(19) United States
(12) Patent Application Publication
(10) Pub. No.: US 2018/0098407 A1
(43) Pub. Date: Apr. 5, 2018

(54) INTEGRATED LIGHTING SYSTEM AND NETWORK

(71) Applicant: RF Digital Corporation, Hermosa Beach, CA (US)

(72) Inventor: Armen E. Kazanchian, Hermosa Beach, CA (US)

(73) Assignee: RF Digital Corporation, Hermosa Beach, CA (US)

(21) Appl. No.: 15/715,556

(22) Filed: Sep. 26, 2017

Related U.S. Application Data
(60) Provisional application No. 62/402,538, filed on Sep. 30, 2016.

(51) Int. Cl. H05B 37/02

(52) U.S. Cl. CPC H05B 37/0227; H05B 37/0272

(57) ABSTRACT

An integrated lighting system and integrated lighting network including integrated lighting systems are communicatively coupled to one another, for example, via various wireless transceivers. The systems and networks can collect data of a passing object (e.g., person, animal, automotive vehicle). The data can be transmitted over the systems and networks such that the intensity of light generated by light fixtures within the systems and networks can be adjusted to the activities of the particular object. In some cases, the data is distance data, gesture data, 2D image data, 3D image data and/or proximity data of the object.

### BACKGROUND

Motion-activated lighting systems can be useful for many tasks requiring the efficient use of electrical power, such as illuminating a stairwell or hallway. These systems often include several illumination sources (e.g., a mercury-vapor lamp or a neon lamp) and, for each illumination source, an optoelectronic device (e.g., including an infrared emitter and detector) operable to detect the motion of an object within its field-of-view. Typically, the optoelectronic devices are unsophisticated by design and are only required to detect motion in to activate a corresponding illumination source.

Such motion-activated lighting systems are ill-equipped for tasks, such as illuminating a path well-ahead of a moving object or optimizing illumination conditions (e.g., intensity) based on an object's location or activity. Systems operable to perform more complex tasks, such as those above, are needed.

### SUMMARY

The present disclosure describes integrated lighting systems and networks operable to perform complex tasks. For example, in one aspect, an integrated lighting system includes an optoelectronic module, a light fixture and a transceiver. The optoelectronic module includes an emitter with an emitter field-of-illumination, and a detector with a detector field-of-view. The light fixture has a light fixture field-of-illumination. Further, the light fixture is communicatively coupled to the optoelectronic module. The transceiver is communicatively coupled to the light fixture and/or the optoelectronic module. The optoelectronic module is operable to collect data of an object, and the light fixture is operable to cast light of a particular intensity on the object.

In another aspect, an integrated lighting network includes a plurality of integrated lighting systems, each of which is coupled to at least one corresponding optoelectronic module and at least one lighting fixture. Each optoelectronic module is operable to collect data of an object, and each light fixture is operable to cast light of a particular intensity on the object.

Some implementations include one or more of the following features. For example, in some instances, the integrated lighting network includes integrated lighting systems communicatively coupled to a cloud computing system.

In some instances, the integrated lighting network includes integrated lighting systems communicatively coupled to a computational device, such as a smartphone, a tablet computer, or a laptop.

In some instances, the integrated lighting network is operable to collect data that corresponds to distance data, gesture data, 2D image data, 3D image data, and/or proximity data.

In some instances, the integrated lighting network is operable to transmit the data to the cloud computing system, wherein the data can be used to configure a command directed to one of the plurality of light fixtures.

In some instances, the integrated lighting network is operable to collect data via the time-of-flight technique.

Other aspects, features and advantages will be readily apparent from the following description, the accompanying drawings and the claims.

### BRIEF DESCRIPTION OF THE DRAWINGS

FIG. 1A illustrates an example integrated lighting system.

FIG. 1B illustrates a portion of the example integrated lighting system depicted in FIG. 1A.

### DETAILED DESCRIPTION

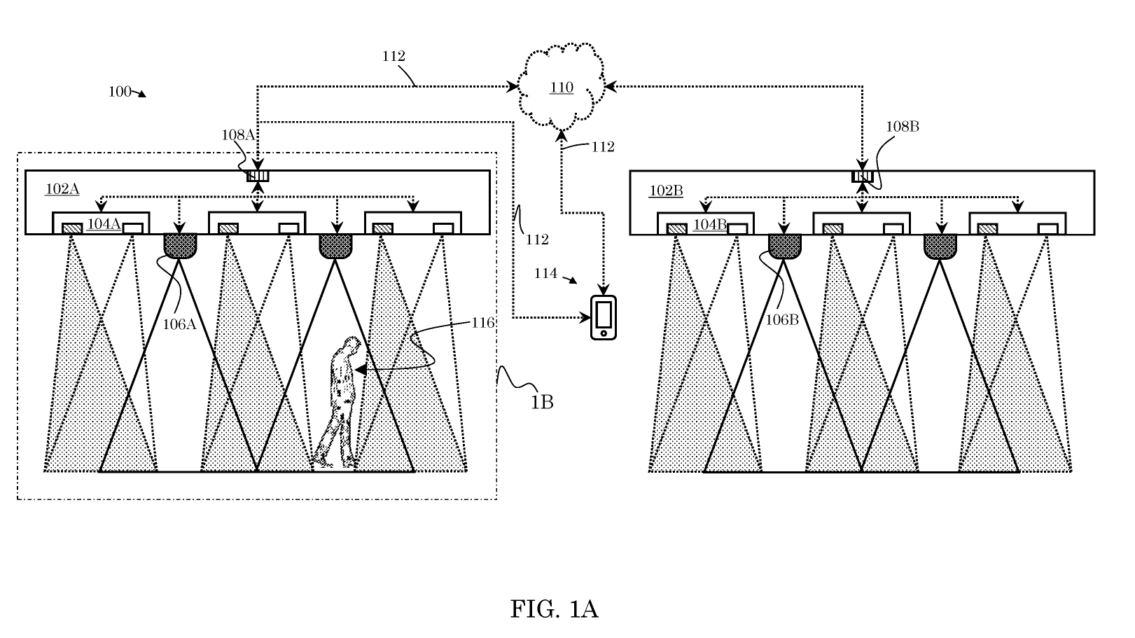

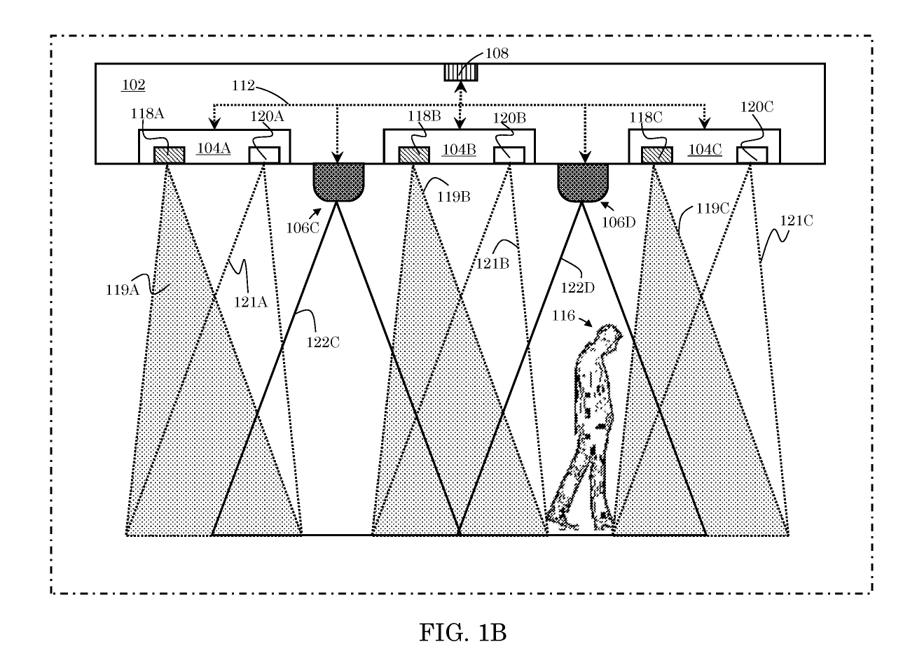

An integrated lighting network 100 is depicted in FIG. 1A, and a portion of the integrated lighting network 100 is depicted in FIG. 1B. The integrated lighting network 100 includes a plurality of integrated lighting systems 102A, 102B. Each integrated lighting system 102A, 102B can be communicatively coupled to each other, and each can include a plurality of optoelectronic modules 104 (e.g., 104A, 104B, 104C) and a plurality of lighting fixtures 106 (e.g., 106A, 106B, 106C, 106D). The optoelectronic modules 104 is operable to collect data of an object 116 (e.g., a person, animal, or automotive vehicle), and the light fixtures 106 are operable to cast light of a particular intensity on the object 116. In some implementations, the optoelectronic module 104 are operable to collect distance data, gesture data, 2D image data, 3D image data and/or proximity data of the object 116. Each of the optoelectronic modules 104 can collect data by generating light over a field-of-illumination 119 (e.g., 119A, 119B, 119C), and by collecting light over an at least partially overlapping fields-of-view 121 (e.g., 121A, 121B, 121C). In some instances, the light corresponds to the infrared portion of the electromagnetic spectrum. In some implementations, the light fixture 106 includes a light-emitting diode, a compact florescent, an incandescent light fixture or another light fixture operable to provide ambient lighting, task lighting, or other lighting, and is operable to cast light over a field of illumination 122 (e.g., 122C, 122D).

In general, the integrated lighting network 100 is operable to detect the object 116 via the integrated lighting systems 102A, 102B and to adjust a particular intensity of the light emitted by the light fixtures 106. For example, the object 116 can be a person walking under the integrated lighting systems 102A, 102B. The intensity of the light fixtures 106 can change so that the person's immediate position is illuminated while other positions along the person's walking path are not illuminated (i.e., the light fixtures 106 can be deactivated/turned off for those positions). Accordingly, electrical power can be used more efficiently.

The integrated lighting systems 102A, 102B can be coupled communicatively to each other and to a cloud computing system 110 via one or more transceivers 108. Each integrated lighting system 102A, 102B can be linked via the cloud in instances where the integrated lighting systems 102A, 102B are spread over large distances, and/or when data collected by the integrated lighting systems 102A, 102B is to be saved, analyzed, or processed in other ways (for applications where cloud computing is necessary or desirable). In some instances, the integrated lighting systems 102A, 102B can be coupled communicatively to each other via two or more transceivers 108 (e.g., 108A, 108B).

Data collected by the first integrated lighting system 102A can be conveyed to the second integrated lighting system 102B (directly or via the cloud computing system 110) and can influence the operation of the light fixtures 106 in one or both integrated lighting systems 102A, 102B. For example, the velocity of the object 116 can be determined by the first integrated lighting system 102A. This velocity data can be transmitted to the second integrated lighting system 102B. Since the position of the first and second integrated lighting systems 102A, 102B are fixed with respect to each other, the velocity data can include estimates for when the object 116 will arrive under the second integrated lighting system 102B. Accordingly, the intensity of the light fixture 106, included within the second integrated lighting system 102B, can be adjusted to illuminate the path of the object (e.g., just prior to) the arrival of the object 116 under the second lighting system 102B.

The foregoing example can be extended to other objects including automotive vehicles. For example, velocity data of an automotive vehicle can be communicated from the first integrated lighting system 102A to the second integrated lighting system 102B before the arrival of the automotive vehicle under the integrated lighting system 102B. Consequently, light fixtures 106 included within the integrated lighting system 102B can be activated before the automotive vehicle arrives at the area under the integrated lighting system 106B (i.e., activated before the automotive vehicle is within the field-of-view 121B). This aspect can improve both the efficiency and safety of highway/street lighting.

In some instances, such as in the foregoing example, the integrated lighting network 100 is operable to identify, or distinguish between, objects. For example, the object 116 detected using the first integrated lighting system 102A can be an automotive vehicle, and another object, such as a deer posing an imminent threat to the object 116, can be identified using the second integrated lighting system 102B. In such instances, the shape, speed, or other characteristics of the object's movement can be collected by the optoelectronic module 104B, wherein the optoelectronic module 104B can include optical systems, image sensors, and 3D illuminators (e.g., structured-light illuminators). The data conveying the shape, speed, or other characteristics of the object's movement can be transmitted via the transceiver 108 to the cloud-computing system 110 and analyzed, wherein the object can be identified, for example, as a deer using object/shape analyzing algorithms. Commands appropriate for the particular scenario can then be directed to either or both of the integrated lighting systems 102A, 102B. For example, the light fixture 106 of the second integrated lighting system 102B can be activated so that the deer is illuminated, and/or the light fixture 106 of first integrated lighting system 102A can be activated to flash in order to warn the automotive vehicle of the impending threat of the object (i.e., a deer in this example).

In some implementations, each integrated lighting system is coupled communicatively to a computational device 114 such as a smartphone, tablet computer or laptop. In some implementations, each integrated lighting system is coupled communicatively to both a computational device 114 and a cloud computing system 110. A warning message indicating the presence of an object posing an imminent threat, such as the deer in the foregoing example, can be directed to the computational device 114.

In some implementations, a customized lighting profile can be saved or loaded onto the computational device 114 and uploaded to the integrated lighting network 100. The customized lighting profile can include specifications for particular lighting tasks. For example, the integrated lighting network 100 can be distributed throughout a dwelling wherein the first integrated lighting system 102A could be positioned in a first room (e.g., an audio-visual entertainment room), and the second lighting system 102B could be positioned in a second room (e.g., a library). The customized lighting profile can include instructions for activating the light fixtures 106 within the first integrated lighting system 102A with a particularly low illumination intensity (e.g., suitable for using an audio-visual entertainment device), and instructions for activating the light fixture 106 within the second integrated lighting system 102B with a particularly high illumination intensity (e.g., suitable for reading). Though illumination intensity is included as an example, other characteristics of the light fixtures 106 can be modified via the customized lighting profile (e.g., color temperature).

In some instances, the integrated lighting systems 102A, 102B can be implemented on a small-scale. For example, the integrated lighting systems 102A, 102B can be incorporated into the dashboard of an automotive vehicle or an audio-visual entertainment device (e.g., gaming system or television). In some implementations, the integrated lighting systems 102A, 102B can be incorporated into various controls and other components typically found on an automotive dashboard (e.g., air conditioning controls, navigation system controls, communication controls, or air conditioning vents). The lighting fixtures 106 included within the first integrated lighting system 102A can be integrated within an air conditioning control knob, and the lighting fixtures 106 included within the second integrated lighting system 102B can be integrated into an actuatable air-conditioning vent, for example. In some instances, the object 116 may be an operator's hand. An action by the operator, say reaching for the air conditioning knob, can activate the lighting fixtures 106A, thereby illuminating the knob. In some instances, another action by the operator may be anticipated, and directions or instructions can be sent (e.g., via the transceiver 108 and/or the cloud computing system 110) to the second integrated lighting system 102B. For example, the lighting fixture 106B can illuminate the actuatable air-conditioning vent, thereby drawing the attention of the operator.

Any of the transceivers described above can include a blue-tooth enabled device or any other device enabled for wireless communication, such as devices employing magnetic-field communication, devices operable to communicate with a cellular network or mobile network, or any other radio-frequency based communication devices.

The example integrated lighting systems described above, and components therein (e.g., optoelectronic modules and audio devices), can further include components necessary for their respective functions such as power sources, processors, circuitry, drivers, firmware, bandpass filters, and so on, as would be apparent to a person of ordinary skill in the art in light of this disclosure. Further, although example integrated lighting systems and methods for operating them are described in detail with reference to certain preferred implementations, other implementations are possible.

In the foregoing description and in the accompanying drawings, reference is made to particular features. However, all possible combinations of such particular features are included within the scope of this description. For example, where a particular feature is disclosed in the context of a particular aspect or embodiment, that feature also can be used, as appropriate, in combination with and/or in the context of other aspects and together with other features.

Moreover, various features disclosed in this disclosure may be replaced by alternative features serving the same, equivalent, or similar purpose, unless expressly stated otherwise. Thus, unless expressly stated otherwise, each feature disclosed is one example only of a generic series of equivalent or similar features. Therefore, other implementations are within the scope of the claims.

What is claimed, is:

1. An integrated lighting system comprising:
an optoelectronic module including an emitter having an emitter field-of-illumination, and a detector having a detector field-of-view;
a light fixture having a light fixture field-of-illumination, the light fixture being coupled communicatively to the optoelectronic module; and
a transceiver communicatively coupled to the light fixture and/or the optoelectronic module;
wherein the optoelectronic module is operable to collect data of an object, and the light fixture is operable to cast light of a particular intensity on the object, and the transceiver is operable to transmit data of the object.

2. The integrated lighting system as in claim 1, wherein the data corresponds to distance data, gesture data, 2D image data, 3D image data, and/or proximity data.

3. The integrated lighting system as in claim 2, wherein the light of the particular intensity corresponds to data collected by the optoelectronic module.

4. The integrated lighting system as in claim 1, wherein the light fixtures are operable to provide a particular intensity of light corresponding to data of the object.

5. The integrated lighting system as in claim 1, wherein the optoelectronic module is operable to collect data via a time-of-flight technique.

6. An integrated lighting network comprising:
a plurality of integrated lighting systems communicatively coupled to one another,
wherein each of the integrated lighting systems includes a plurality of optoelectronic modules and a plurality of lighting fixtures,
the plurality of optoelectronic modules being operable to collect data of an object, and the plurality of light fixtures being operable to cast light of a respective particular intensity on the object.

7. The integrated lighting network of claim 6, wherein each of the integrated lighting systems is communicatively coupled to a cloud computing system.

8. The integrated lighting network as in claim 7, wherein the data collected by one of the optoelectronic modules in a first integrated lighting system is transmitted to a cloud computing system operable to transform the data into a command that is directed to a light fixture in a second integrated lighting system.

9. The integrated lighting network of claim 6, wherein each of the integrated lighting systems is communicatively coupled to a computational device.

10. The integrated lighting network as in claim 9, wherein the computational device is a smartphone, a tablet computer, or a laptop.

11. The integrated lighting network as in claim 6, wherein the data corresponds to distance data, gesture data, 2D image data, 3D image data, and/or proximity data.

12. The integrated lighting network as in claim 11, wherein the light of the particular intensity corresponds to data collected by one or more of the optoelectronic modules.

13. The integrated lighting network as in claim 2, wherein the light fixtures are operable to provide a particular intensity of light corresponding to data of the object.

14. The integrated lighting network as in claim 2, in which at least one of the optoelectronic modules is operable to collect data via a time-of-flight technique.
